(19) United States
(12) Patent Application Publication
(10) Pub. No.: US 2006/0204792 A1
(43) Pub. Date: Sep. 14, 2006

(54) MAGNETIC RECORDING MEDIUM, PRODUCTION PROCESS THEREFOR, AND MAGNETIC RECORDING AND REPRODUCING APPARATUS

(76) Inventor: Hiroshi Osawa, CHIBA-KEN (JP)

Correspondence Address: SUGHRUE MION, PLLC, 2100 PENNSYLVANIA AVENUE, N.W., SUITE 800, WASHINGTON, DC, 20037, US

(21) Appl. No.: 10/550,273

(22) PCT Filed: Apr. 6, 2004
(86) PCT No.: PCT/JP04/04959

§ 371 Date: Sep. 23, 2005

(51) Int. Cl. G11B 5/66

(52) U.S. Cl. 428/829; 428/836.1

(57) ABSTRACT

An object of the present invention is to provide a magnetic recording medium which can reduce media noise. The present invention provides a magnetic recording medium comprising at least a non-magnetic undercoat layer, a first magnetic layer, a non-magnetic coupling layer, a second magnetic layer, and a protective layer, in this order, on a non-magnetic substrate, wherein the second magnetic layer is anti-ferromagnetically coupled with the first magnetic layer, and the first magnetic layer is made of a CoCrZr alloy.

### CROSS-REFERENCE TO RELATED APPLICATIONS

This application claims the benefit pursuant to 35 U.S.C. §119 (e) of U.S. Provisional Application No. 60/461,802 filed on Apr. 11, 2003.

This application is based on Japanese Patent Application No. 2003-103367 filed in Japan on Apr. 7, 2003, the content of which is incorporated herein by reference.

### TECHNICAL FIELD

The present invention relates to a magnetic recording medium for use in a hard disk drive or a similar apparatus, to a method for producing the magnetic recording medium, and to a magnetic recording and reproducing apparatus. In particular, the present invention relates to a magnetic recording medium in which media noise is reduced, to a method for producing the magnetic recording medium, and to a magnetic recording and reproducing apparatus.

### BACKGROUND ART

At present, recording density of hard disk drives (HDD) which are a type of magnetic recording and reproducing apparatus, is increasing at a rate of 60% per year, and this trend is expected to continue.

A magnetic recording medium for use in a hard disk drive is desired to have an increased recording density, and therefore, the recording medium is required to have enhanced coercive force and reduced noise.

A mainstream magnetic recording medium employed in a hard disk drive has a structure in which a metal film is stacked on a magnetic recording medium substrate through sputtering.

Substrates employed as magnetic recording medium substrates include an aluminum substrate and a glass substrate, which are widely used. A typically employed aluminum substrate is produced by forming an NiP film having a thickness of about 10 μm on a mirror-polished Al—Mg alloy substrate through electroless plating, and mirror-polishing the surface. Regarding the glass substrate, an amorphous glass substrate and a glass-ceramic substrate are employed. Either type of glass substrate is mirror-polished prior to use.

At present, magnetic recording media which are generally used in a hard disk drive have a structure in which a non-magnetic undercoat layer (e.g., an NiAl alloy, Cr, or a Cr alloy), a non-magnetic intermediate layer (e.g., a CoCr alloy or a CoCrTa alloy), a magnetic layer (e.g., Co—Cr—Pt—Ta-based alloy or Co—Cr—Pt—B-based alloy), and a protective layer (e.g., carbon) are sequentially formed on a non-magnetic substrate, the protective layer being coated with a lubricant layer.

In order to improve a recording density, it is necessary to improve an SNR (signal to noise ratio) during recording at high-frequency. Kenneth, E. J., “Magnetic materials and structures for thin-film recording media”, JOURNAL OF APPLIED PHYSICS Vol. 87, No. 9, 5365 (2000) says that in order to improve an SNR, it is necessary for the diameter of crystal grains in a recording layer (magnetic layer) to be small and uniform.

However, when the diameter of crystal grains in a recording layer (magnetic layer) is made to be small and uniform to improve the SNR, the volume of the crystal grains is smaller and the crystal grains are thermally unstable. This is reported in Sharat Batra et al., “Temperature Dependence of Thermal Stability in Longitudinal Media”, IEEE Trans. Magn. Vol. 35, No. 5, 2736 (1999).

As one solution to this problem, a magnetic recording medium, in which a magnetic layer is formed both on and under a non-magnetic coupling layer made of ruthenium and the like and the magnetization directions of these magnetic layers are made to be opposite to each other and to be parallel, has been suggested in Japanese Unexamined Patent Application, First Publication No. 2001-56921.

In the magnetic recording medium, since the magnetization direction of the two magnetic layers are opposite to each other, a portion participating in magnetically recording and reproducing is substantially thinner than the entirety of the recording layer. Due to this, SNR can be improved. On the other hand, the volume of the crystal grains in the overall recording layer becomes large; therefore, thermal instability can be improved.

Media adopting this technique are generally called AFC media (Anti-Ferromagnetically-Coupled Media) or SFM (Synthetic Ferrimagnetic Media). Here, this is simply called AFC media or medium.

In the magnetic recording medium disclosed in Japanese Unexamined Patent Application, First Publication No. 2001-56921, a magnetic layer is formed on and under a non-magnetic coupling layer so as to sandwich it. In this magnetic recording medium, a magnetic layer formed at a non-magnetic substrate side is a ferromagnetic layer. The ferromagnetic layer is made of at least one of Co, Ni, Fe, an Ni-based alloy, an Fe-based alloy, a Co-based alloy (containing CoCrTa, CoCrPt, and CoCrPtM). Moreover, a symbol M denotes B, Mo, Nb, Ta, W, Cu, or an alloy containing the element).

However, it is difficult to reduce media noise sufficiently to respond to an increased recording density in a conventional recording medium.

The present invention has been accomplished in view of the foregoing, and an object of the present invention is to provide a magnetic recording medium which can sufficiently decrease media noise, a method for producing the magnetic recording medium, and a magnetic recording and reproducing apparatus comprising the magnetic recording medium.

### DISCLOSURE OF INVENTION

The present inventor has conducted extensive research to solve the problems, and has found that the media noise can be decreased and high recording density can be achieved by employing a CoCrZr alloy as a first magnetic layer. The present invention has been made on the basis of this finding.

(1) A first invention to solve the problems is a magnetic recording medium comprising at least a non-magnetic undercoat layer, a first magnetic layer, a non-magnetic coupling layer, a second magnetic layer, and a protective layer, in this order, on a non-magnetic substrate, wherein the second magnetic layer is anti-ferromagnetically coupled with the first magnetic layer, and the first magnetic layer is made of a CoCrZr alloy.

(2) A second invention to solve the problems is a magnetic recording medium comprising at least a non-magnetic undercoat layer, a first magnetic layer, a non-magnetic coupling layer, a second magnetic layer, a non-magnetic coupling layer, a third magnetic layer, and a protective layer, in this order, on a non-magnetic substrate, wherein the third magnetic layer is antiferromagnetically coupled with the second magnetic layer, the second magnetic layer is antiferromagnetically coupled with the first magnetic layer, and the first magnetic layer is made of a CoCrZr alloy.

(3) A third invention to solve the problems is a magnetic recording medium as described in (1) or (2), wherein the first magnetic layer contains 5 to 22 at. % of Cr and 1 to 10 at. % of Zr.

(4) A fourth invention to solve the problems is a magnetic recording medium as described in any one of (1) to (3), wherein the thickness of the first magnetic layer is in a range of 0.5 to 10 nm.

(5) A fifth invention to solve the problems is a magnetic recording medium as described in any one of (1) to (4), wherein the non-magnetic coupling layer is made of at least one of Ru, Rh, Ir, Cr, Re, an Ru-based alloy, an Rh-based alloy, an Ir-based alloy, a Cr-based alloy, and an Re-based alloy; and the thickness of the non-magnetic coupling layer is in a range of 0.5 to 1.5 nm.

(6) A sixth invention to solve the problems is a magnetic recording medium as described in any one of (1) to (5), wherein the non-magnetic undercoat layer has a multi-layer structure comprising a layer made of Cr or a layer made of Cr-based alloy containing Cr and at least one of Ti, Mo, Al, Ta, W, Ni, B, Si, and V.

(7) A seventh invention to solve the problems is a magnetic recording medium as described in any one of (1) to (6), wherein the non-magnetic undercoat layer has a multi-layer structure comprising a layer containing one of an NiAl-based alloy, an RuAl-based alloy, and a Cr alloy, and the Cr alloy contains Cr and at least one of Ti, Mo, Al, Ta, W, Ni, B, Si, and V.

(8) An eighth invention to solve the problems is a magnetic recording medium as described in any one of (1) to (7), wherein the non-magnetic substrate is one of a glass substrate and a silicon substrate.

(9) A ninth invention to solve the problems is a magnetic recording medium as described in any one of (1) to (8), wherein the non-magnetic substrate comprises a substrate made of one of Al, an Al alloy, glass, and silicon, on which a film made of NiP or an NiP alloy is formed.

(10) A tenth invention to solve the problems is a magnetic recording medium as described in any one of (1) to (9), wherein the second magnetic layer is made of at least one of a CoCrTa-based alloy, a CoCrPtTa-based alloy, a CoCrPtB-based alloy, and a CoCrPtBM-based alloy (wherein M denotes at least one of Ta and Cu).

(11) An eleventh invention to solve the problems is a magnetic recording medium as described in any one of (2) to (9), wherein the second magnetic layer and the third magnetic layer are made of at least one of a CoCrTa-based alloy, a CoCrPtTa-based alloy, a CoCrPtB-based alloy, and a CoCrPtBM-based alloy (wherein M denotes at least one of Ta and Cu).

(12) A twelfth invention to solve the problems is a method for producing a magnetic recording medium comprising at least a non-magnetic undercoat layer, a first magnetic layer, a non-magnetic coupling layer, a second magnetic layer, and a protective layer, in this order, on a non-magnetic substrate; and the second magnetic layer being anti-ferromagnetically coupled with the first magnetic layer, wherein the method comprises the step in which the first magnetic layer is made of a CoCrZr alloy.

(13) A thirteenth invention to solve the problems is a method for producing a magnetic recording medium comprising at least a non-magnetic undercoat layer, a first magnetic layer, a non-magnetic coupling layer, a second magnetic layer, a non-magnetic coupling layer, a third magnetic layer, and a protective layer, in this order, on a non-magnetic substrate; the third magnetic layer being anti-ferromagnetically coupled with the second magnetic layer; and the second magnetic layer being anti-ferromagnetically coupled with the first magnetic layer, wherein the method comprises the step in which the first magnetic layer is made of a CoCrZr alloy.

(14) A fourteenth invention to solve the problems is a magnetic recording and reproducing apparatus comprising a magnetic recording medium as recited in any one of (1) to (11) and a magnetic head for recording information in the magnetic recording medium and reproducing information from the magnetic recording medium.

### BRIEF DESCRIPTION OF THE DRAWINGS

FIG. 1 is a cross-sectional view showing a first embodiment of the magnetic recording medium of the present invention.

FIG. 2 is a cross-sectional view showing a second embodiment of the magnetic recording medium of the present invention.

FIG. 3 is a cross-sectional view showing a third embodiment of the magnetic recording medium of the present invention.

FIG. 4 is a cross-sectional view showing a fourth embodiment of the magnetic recording medium of the present invention.

FIG. 5 is a cross-sectional view showing a fifth embodiment of the magnetic recording medium of the present invention.

FIG. 6 is a view for explaining a Hex measuring method.

FIG. 7 is a schematic view of an exemplary magnetic recording and reproducing apparatus according to the present invention.

### MODES FOR CARRYING OUT THE INVENTION

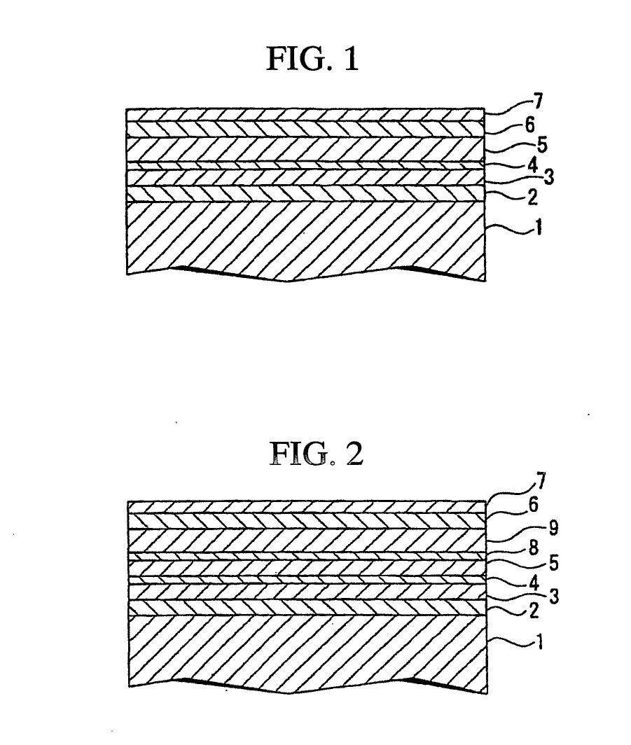

FIG. 1 schematically shows a first embodiment of the magnetic recording medium of the present invention. In the magnetic recording medium as shown in FIG. 1, a non-magnetic undercoat layer 2, a first magnetic layer 3, a non-magnetic coupling layer 4, a second magnetic layer 5, a protective layer 6, and a lubrication layer 7 are sequentially stacked in this order on a non-magnetic substrate 1.

FIG. 2 schematically shows a second embodiment of the magnetic recording medium of the present invention. In the magnetic recording medium as shown in FIG. 2, a non-magnetic undercoat layer 2, a first magnetic layer 3, a first non-magnetic coupling layer 4, a second magnetic layer 5, a second non-magnetic coupling layer 8, a third magnetic layer 9, a protective layer 6, and a lubrication layer 7 are sequentially stacked in this order on a non-magnetic substrate 1.

The non-magnetic substrate 1 is preferably an aluminum substrate or an aluminum alloy substrate comprising NiP or an NiP-based alloy film thereon.

Examples of the non-magnetic substrate 1 further include substrates made of a non-metallic material such as glass, ceramics, silicon, silicon carbide, carbon, or resin. A substrate made of such a nonmetallic material and comprising an NiP film or an NiP-based alloy film on the non-metallic material may also be used.

In particular, the non-magnetic substrate 1 is preferably a substrate which is made of one selected from Al, an Al alloy, glass, and silicon and comprises an NiP film or an NiP alloy film.

The non-metallic material is preferably glass or silicon, from the viewpoint of surface flatness. In particular, a glass substrate is more preferably used, from the viewpoint of cost and durability. Examples of glass materials which can be employed as the non-magnetic substrate include an amorphous glass and a glass ceramic.

Examples of the amorphous glass include generally used soda-lime glass, aluminoborosilicate glass, and aluminosilicate glass. Examples of the glass ceramics include lithium-containing glass ceramics.

Examples of the ceramic substrate include a sintered product predominantly containing generally used alumina, silicon nitride, or a similar compound, and a fiber-reinforced product thereof.

In a magnetic recording and reproducing apparatus, in order to enhance recording density, the flying height of a magnetic head is required to be reduced. Thus, the non-magnetic substrate 1 desirably has enhanced surface flatness. Specifically, the non-magnetic substrate 1 desirably has a surface average roughness (Ra) of 2 nm or less, preferably 1 nm or less.

The non-magnetic substrate 1 preferably has texturing grooves, which are made by a texturing process, on the surface thereof. The texturing process is preferably conducted so that the surface average roughness of the non-magnetic substrate 1 is in a range of 0.1 nm to 0.7 nm, (more preferably in a range of 0.1 nm to 0.5 nm, and most preferably in a range of 0.1 nm to 0.35 nm). The texturing grooves are preferably formed in a generally circumferential direction of the non-magnetic substrate 1, from the viewpoint of enhancement of magnetic anisotropy in a circumferential direction of the magnetic recording medium.

The non-magnetic substrate 1 preferably has a surface micro-waviness (Wa) of 0.3 nm or less (more preferably 0.25 nm or less).

At least one of a chamfer section of the end surface and a side surface of the non-magnetic substrate 1 preferably has a surface average roughness (Ra) of 10 nm or less (more preferably 9.5 nm or less), from the viewpoint of flying stability of a magnetic head.

The micro-waviness (Wa) can be determined by means of, for example, a surface average roughness meter (P-12, product of KLM-Tencor (USA)) as a surface average roughness value as measured in a range of 80 μm.

On the non-magnetic substrate 1, the non-magnetic undercoat layer 2 is formed. The non-magnetic undercoat layer 2 may be a one-layer structure or a multi-layer structure comprising a plurality of layers.

The non-magnetic undercoat layer 2 may be made of a Cr alloy containing Cr and at least one of Ti, Mo, Al, Ta, W, Ni, B, Si, and V. The non-magnetic undercoat layer 2 may also be made of Cr.

When the non-magnetic undercoat layer 2 has a multi-layer structure, at least one of layers comprising the non-magnetic undercoat layer 2 may be made of the Cr alloy or Cr.

The non-magnetic undercoat layer 2 is preferably made of at least one of an NiAl-based alloy, an RuAl-based alloy, and a Cr alloy containing Cr and at least one of Ti, Mo, Al, Ta, W, Ni, B, Si, and V.

When the non-magnetic undercoat layer 2 has a multi-layer structure, at least one of the layers comprising the non-magnetic undercoat layer 2 may be made of at least one of an NiAl-based alloy, an RuAl-based alloy, and the Cr alloy.

The thickness of the non-magnetic undercoat layer 2 having a one layer structure is preferably in a range of 1 to 40 nm (more preferably 3 to 15 nm). If the thickness of the non-magnetic undercoat layer 2 is less than 1 nm, crystal growth is insufficient. If this exceeds 40 nm, crystal grains are too large, and thereby increase media noise.

The non-magnetic undercoat layer 2 preferably has a multi-layer structure. If the non-magnetic undercoat layer 2 has a multi-layer structure, crystals are orientated and electromagnetic transducing characteristics are improved.

When the non-magnetic undercoat layer 2 having a multi-layer structure is formed, the thickness of a layer comprising the non-magnetic undercoat layer 2 may be in a range of 1 to 40 nm (more preferably in a range of 3 to 15 nm). If the thickness of the layer is less than 1 nm, crystal growth is insufficient. In contrast, if the thickness exceeds 40 nm, the crystal grains are too large and thereby increasing media noise.

The total thickness of the non-magnetic undercoat layer 2 having a multi-layer structure may be in a range of 3 to 150 nm.

The first magnetic layer 3 is made of a CoCrZr-based alloy. In the first magnetic layer 3, the content of Cr is preferably in a range of 5 to 22 at. %, and the content of Zr is preferably in a range of 1 to 10 at. %, from the viewpoint of an SNR.

The thickness of the first magnetic layer 3 is preferably in a range of 0.5 to 10 nm (and more preferably in a range of 0.5 to 5 nm). If the thickness is less than 0.5 mm, epitaxial growth is insufficient, and thereby sufficient coercive force cannot be obtained. In contrast, if the thickness exceeds 10 nm, the part, in which an anti-ferromagnetic coupling is not occurring, increases media noise.

A CoCrZr-based alloy making the first magnetic layer 3 may contain an additional element having an auxiliary effect (e.g., enhancing orientation, grain size reduction). Examples of the additional element include one or more species selected from among Ti, V, Mn, Hf, Ru, B, Al, Si, and W. The total content of the additional elements is preferably 10 at. % or less. If the total content exceeds 10 at. %, the effect (enhancing orientation or grain-size-reduction) is reduced. If the content is less than 0.1 at. %, the effect is also reduced. Thus, the total content is more preferably controlled in a range of 0.1 to 10 at. %.

The non-magnetic coupling layers 4 and 8 are preferably made of one selected from among Ru, Rh, Ir, Cr, Re, an Ru-based alloy, an Rh-based alloy, an Ir-based alloy, a Cr-based alloy, and an Re-based alloy.

Since these materials have large exchange energy constant, when the non-magnetic coupling layer is made of one of these materials, it is possible to approach the magnetization directions of the magnetic layers, which are positioned on and under the non-magnetic coupling layer, to the conditions in which the magnetization directions are opposite to each other and are parallel.

In particular, since Ru has the largest coupling energy coefficient among these materials, Ru is preferably used for the non-magnetic coupling layers 4 and 8.

The coupling energy coefficient denotes strength of exchange interaction between the magnetic layers, which are positioned thereon and thereunder. The non-magnetic coupling layer preferably has a larger coupling energy coefficient.

The thickness of the non-magnetic coupling layer 4 and 8 is preferably in a range of 0.5 to 1.5 mm (and more preferably in a range of 0.6 to 1.0 nm). If the non-magnetic coupling layers 4 and 8 have a thickness in this range, the non-magnetic coupling layers 4 and 8 have sufficient anti-ferromagnetic coupling.

The non-magnetic coupling layer, which is explained above, is not applied to the non-magnetic coupling layer 4 shown in FIG. 1, and this can be used for the first and second non-magnetic coupling layers 4 and 8 shown in FIG. 2.

The second and third magnetic layers may be made of materials other than a CoCrZr-based alloy, such as a Co alloy containing Co as a main component and having a hcp structure.

Specifically, the second and third magnetic layers may be made of one or more alloys selected from among a CoCrTa-based alloy, a CoCrPt-based alloy, a CoCrPtTa-based alloy, a CoCrPtB-based alloy, a CoCrPtBTa-based alloy, a CoCrPtBCu-based alloy, a CoRuTa-based alloy, and a CoCrPtBM-based alloy (wherein M is at least one of Ta and Cu).

Among these, at least one selected from a CoCrTa-based alloy, a CoCrPtTa-based alloy, a CoCrPtB-based alloy, and a CoCrPtBM-based alloy (wherein M is at least one of Ta and Cu) is preferably used.

When a CoCrPt-base alloy is used for the second and third magnetic layers, the content of Cr is preferably in a range of 10 to 25 at. %, and the content of Pt is preferably in a range of 8 to 16 at. %, from the viewpoint of an SNR.

When a CoCrPtB-base alloy is used, the content of Cr is preferably in a range of 10 to 25 at. %, the content of Pt is preferably in a range of 8 to 16 at. %, and the content of B is preferably in a range of 1 to 20 at. %, from the viewpoint of an SNR.

When a CoCrPtBTa-base alloy is used, the content of Cr is preferably in a range of 10 to 25 at. %, the content of Pt is preferably in a range of 8 to 16 at. %, the content of B is preferably in a range of 1 to 20 at. %, and the content of Ta is preferably in a range of 1 to 4 at. %, from the viewpoint of an SNR.

When a CoCrPtBCu-base alloy is used, the content of Cr is preferably in a range of 10 to 25 at. %, the content of Pt is preferably in a range of 8 to 16 at. %, the content of B is preferably in a range of 1 to 20 at. %, and the content of Cu is preferably in a range of 1 to 4 at. %, from the viewpoint of an SNR.

In the magnetic recording medium comprising two magnetic layers (that is, the first and second magnetic layers 3 and 5) as shown in FIG. 1, the thickness of the second magnetic layer 5 is preferably 10 nm or greater, from the viewpoint of thermal stability characteristics. From the viewpoint of high recording density, the thickness of the second magnetic layer 5 is preferably 40 nm or less. This is because, if the thickness exceeds 40 nm, the favorable recording and reproducing characteristics cannot be obtained.

In the magnetic recording medium comprising three magnetic layers (that is, the first to third magnetic layers 3, 5, and 9) as shown in FIG. 2, the thickness of the second magnetic layer 5 is preferably 2 to 15 nm, in order to improve the strength of anti-ferromagnetic coupling between the second magnetic layer 5 and the first magnetic layer 3 and the strength of anti-ferromagnetic coupling between the second magnetic layer 5 and the third magnetic layer 9.

The thickness of the third magnetic layer 9 is preferably 10 nm or greater, from the viewpoint of thermal stability characteristics. From the viewpoint of high recording density, the thickness of the third magnetic layer 9 is preferably 40 nm or less. This is because, if the thickness exceeds 40 nm, the favorable recording and reproducing characteristics cannot be obtained.

Each of the magnetic layers (the first to third magnetic layers 3, 5, and 9) may have a multi-layer structure comprising a plurality of layers. When the magnetic layer has a multi-layer structure, materials used for the first to third magnetic layers can be used for a layer comprising a multi-layer structure.

In the present invention, in order to promote epitaxial growth of the non-magnetic undercoat layer 2, an orientation adjustment layer, which is made of metallic material, may be formed between the non-magnetic substrate 1 and the non-magnetic undercoat layer 2.

Examples of material making the orientation adjustment layer include a CoW-based alloy, a CoMo-based alloy, a CoTa-based alloy, a CoNb-based alloy, an NiP-based alloy, an NiTa-based alloy, an FeMo-based alloy, an FeW-based alloy, an ReW-based alloy, an ReMo-based alloy, an RuW-based alloy, and an RuMo-based alloy.

The orientation adjustment layer may be subjected to a surface treatment in which the surface is allowed to contact with O₂ and gas containing oxygen such as air. The thickness of the orientation adjustment layer is preferably in a range of 5 to 50 nm, from the viewpoint of epitaxial growth of the non-magnetic undercoat layer 2.

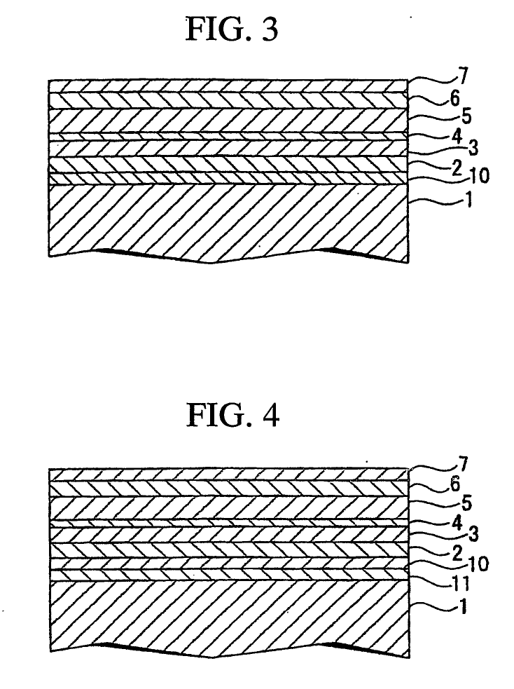

FIG. 3 shows one embodiment of the magnetic recording medium comprising the orientation adjustment layer of the present invention. The magnetic recording medium comprises the orientation adjustment layer 10 between the non-magnetic substrate 1 and the non-magnetic undercoat layer 2.

Furthermore, in order to improve adhesion between the non-magnetic substrate 1 and the orientation adjustment layer 10, an adhesion layer may be formed between the non-magnetic substrate 1 and the orientation adjustment layer 10.

The adhesion layer may be made of at least one of Cr, Ta, Ti, and W. The thickness of the adhesion layer is preferably in a range of 1 to 100 nm (more preferably in a range of 5 to 80 nm, and most preferably in a range of 7 to 70 nm), from the viewpoint of adhesion and productivity.

FIG. 4 shows another embodiment of the magnetic recording medium comprising the adhesion layer of the present invention. The magnetic recording medium comprises the adhesion layer 11 between the non-magnetic substrate 1 and the orientation adjustment layer 10.

In order to promote epitaxial growth of the first magnetic layer 3, a non-magnetic intermediate layer may be formed between the non-magnetic undercoat layer 2 and the first magnetic layer 3. When the non-magnetic intermediate layer is formed, the effects for improving magnetic characteristics (e.g., coercive force) and recording-reproducing characteristics (e.g., an SNR) can be obtained.

The non-magnetic intermediate layer may be made of Co and Cr. When the non-magnetic intermediate layer is made of a CoCr-based alloy, the content of Cr is preferably in a range of 25 to 45 at. %, from the viewpoint of enhancing an SNR. The thickness of the non-magnetic intermediate layer is preferably in a range of 0.5 to 3 nm, from the viewpoint of enhancing an SNR.

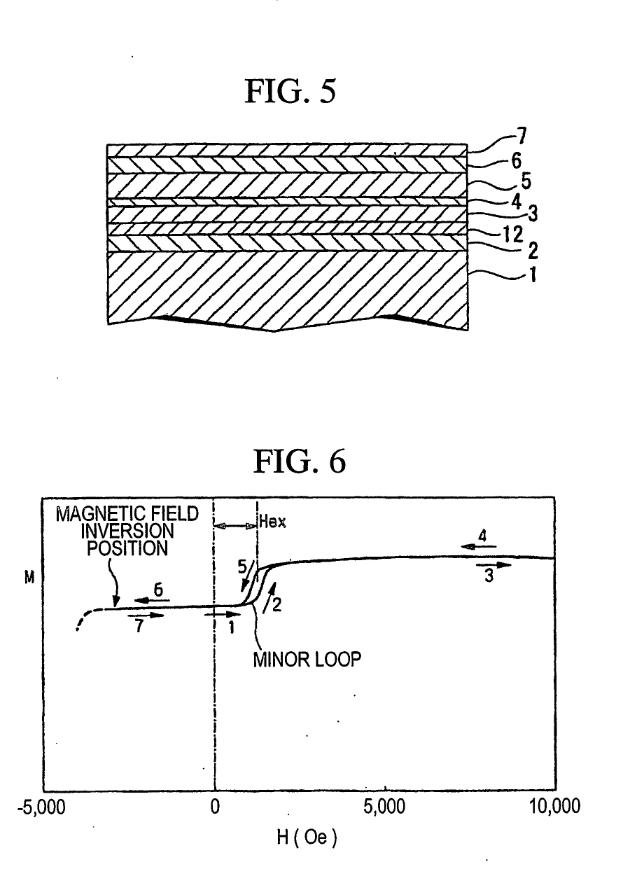

FIG. 5 shows another embodiment of the magnetic recording medium comprising the non-magnetic intermediate layer of the present invention. The magnetic recording medium comprises the non-magnetic intermediate layer 12 between the non-magnetic undercoat layer 2 and the first magnetic layer 3.

The protective layer 6 may be made of well-known materials as a protective layer such as carbon and SiC.

The thickness of the protective layer 6 is preferably in a range of 1 to 10 nm, from the viewpoint of spacing loss when a recording density is increased and durability of the medium.

On the protective layer 6, a lubrication layer 7 made of a fluorine-containing lubricant such as perfluoropolyether may be formed in accordance with needs.

The recording medium of the present invention is an AFC medium in which the magnetic direction of a plurality of the magnetic layers, which are provided on and under the non-magnetic coupling layer, can be adjusted to be opposite to each other and be parallel.

In other words, in the magnetic recording medium of the present invention, the second magnetic layer 5 can be an anti-ferromagnetic coupled with the first magnetic layer 3. In addition, the third magnetic layer 9 can be an anti-ferromagnetic coupled with the second magnetic layer 5, and the second magnetic layer 5 can be an anti-ferromagnetic coupled with the first magnetic layer 3.

Hex (exchange coupling strength) or J (exchange joint coefficient) can be used for an index showing the strength of anti-ferromagnetic coupling.

Hex is preferably 500 (Oe) or greater, and J is preferably 0.2 erg/cm² or greater.

Moreover, 1 erg/cm²=0.001 J/m², 1 Oe ≈79.577475 A/m, and 1 emul≈12.5664×10⁻⁴ Wb/m².

Hex is defined as a magnetic field strength from the center of a minor loop to 0 when coercive field strength is measured and the minor loop is made.

When Hex is larger, the magnetic coupling between the magnetic layers, which are provided on and under the non-magnetic coupling layer, is stronger, and they are more stable.

FIG. 6 shows one example of the minor loop. One method for making the minor loop is explained referring to FIG. 6.

First, magnetic filed strength increases from 0 (Oe) to the largest measuring magnetic field strength (for example, 10,000 (Oe)) (in FIG. 6, the step: 1→2→3).

After that, the magnetic field is inverted, then the magnetic filed strength is allowed to decrease from the largest measuring numerical value (for example, 10,000 (Oe)). The magnetic field strength gradually decreases and then the magnetic field strength suddenly falls, and thereby a magnetization line makes a curve. After that, the magnetic field strength is further allowed to decrease to a numerical value (for example, −3,000 (Oe)) which is larger by 1,000 (Oe) than the magnetic field strength suddenly starting to fall again (in FIG. 6, the step: 4→5→6). Then, the magnetic filed is inverted again, the magnetic field strength is allowed to increase from the numerical value (for example, −3,000 (Oe)), at which the magnetic filed is inverted, to the largest measuring numerical value (for example, 10,000 (Oe))(in FIG. 6, the step: 7→2→3). The hysteresis curve obtained by these steps is the minor loop.

J is calculated by the following formula.
J=Hex×Ms₁×t₁

wherein Ms₁ denotes a saturation magnetization (emu/cc) of the first magnetic layer 3, and t₁, denotes the thickness of the first magnetic layer 3. Ms₁ can be obtained by the minor loop.

Next, one example of the method for producing the magnetic recording medium of the present invention will be explained.

The surface of the non-magnetic substrate 1 is subjected to a texturing process, if necessary. As the texturing process, a mechanical texturing using an abrasive tape can be adopted.

The texturing process can be performed along with oscillation. The process “oscillation” refers to an operation of oscillating an abrasive tape in a radial direction of the non-magnetic substrate 1 while the abrasive tape is moved on the non-magnetic substrate 1 in a circumferential direction. The oscillation speed is preferably 60 to 1,200 cycles/minute, so that the surface of the non-magnetic substrate 1 is uniformly polished.

Other than the mechanical texturing process employing an abrasive tape, there may be employed a texturing method employing immobilized abrasives, a texturing method employing an immobilized grinding wheel, a laser processing, etc.

The texturing process is preferably performed such that the grooves having a line density of 7,500 lines/mm or more are formed on the surface of the non-magnetic substrate 1.

After washing of the non-magnetic substrate 1 is complete, the non-magnetic substrate 1 is placed in a chamber of a film formation apparatus. The non-magnetic substrate 1 is heated to 100 to 400° C. in accordance with need.

Through sputtering (for example, DC or RF magnetron sputtering), the non-magnetic undercoat layer 2, the first magnetic layer 3, the non-magnetic coupling layer 4, and the second layer 5 (or the non-magnetic undercoat layer 2, the first magnetic layer 3, the first non-magnetic coupling layer 4, the second magnetic layer 5, the second non-magnetic coupling layer 8, and the third magnetic layer 9) are formed on the non-magnetic substrate 1.

The following operational conditions of sputtering can be employed for forming these layers.

The non-magnetic substrate 1 is put into the chamber, and the chamber is evacuated so that the degree of vacuum is in a range of 1×10⁻⁴ to 1×10⁻⁷ Pa. Sputtering gas such as Ar is introduced into the chamber and discharge is conducted. The electric power supplied is preferably 0.2 to 2.0 kW. By controlling the discharge time and the electric power supplied, the thickness of the formed film can be adjusted.

Specifically, for example, the magnetic recording medium of the present invention is made by the following processes.

On the non-magnetic substrate 1, the non-magnetic undercoat layer 2 having a thickness of 3 to 15 nm is formed using a sputtering target such as Cr, a Cr alloy, an NiAl-based alloy, or an RuAl-based alloy.

Next, the first magnetic layer 3 having a thickness of 0.5 to 5 nm is formed using a CoCrZr-based alloy.

Then, the non-magnetic coupling layer 4 having a thickness of 0.5 to 1.5 nm (and more preferably in a range of 0.6 to 1.0 μm) is formed using a sputtering target such as Ru, Rh, Ir, Cr, Re, a Ru-based alloy, an Rh-based alloy, an Ir-based alloy, a Cr-based alloy, or an Re-based alloy.

Then, the second magnetic layer 5 having a thickness of 10 to 40 nm is formed using a sputtering target such as a CoCrTa-based alloy, a CoCrPt-based alloy, a CoCrPtTa-based alloy, a CoCrPtB-based alloy, a CoCrPtBTa-based alloy, a CoCrPtBCu-based alloy or a CoRuTa-based alloy.

After that, the protective layer 6 is made by a conventionally known method such as sputtering, and plasma CVD.

On the protective layer 6, a lubrication layer 7 can be formed through a conventionally known method such as spin coating or dipping, if necessary.

When the orientation adjustment layer 10 is formed between the non-magnetic substrate 1 and the non-magnetic undercoat layer 2, before producing the non-magnetic undercoat layer 2, the orientation adjustment layer 10 is formed using a sputtering target which is selected from the materials comprising the orientation adjustment layer 10.

When the adhesion layer 11 is formed between the non-magnetic substrate 1 and the orientation adjustment layer 10, before producing the orientation adjustment layer 10, the adhesion layer 11 is formed using a sputtering target which is selected from the materials comprising the adhesion layer 11.

Since the magnetic recording medium comprises the first magnetic layer made of a CoCrZr-based alloy, media noise can be reduced.

The magnetic recording medium has a characteristic in which a CoCrZr-based alloy is used for only the first magnetic layer, which is a layer positioned nearest to the non-magnetic substrate among a plurality of the magnetic layers.

For example, in the magnetic recording medium shown in FIG. 1, among two magnetic layers, that is, the first and second magnetic layer 3 and 5, only the first magnetic layer 3 is made of a CoCrZr-based alloy. In the magnetic recording medium shown in FIG. 2, among three magnetic layers, that is, the first, second, and third magnetic layers 3, 5, and 9, only the first magnetic layer 3 is made of a CoCrZr-based alloy.

Due to this, media noise can be reduced in the magnetic recording medium of the present invention. In contrast, in the magnetic recording medium comprising a magnetic layer made by a CoCrZr-based alloy, which is other than the first magnetic layer, media noise increases.

Since the magnetic recording medium is an AFC medium in which the magnetic layers are anti-ferromagnetic coupled, thermal stability is improved.

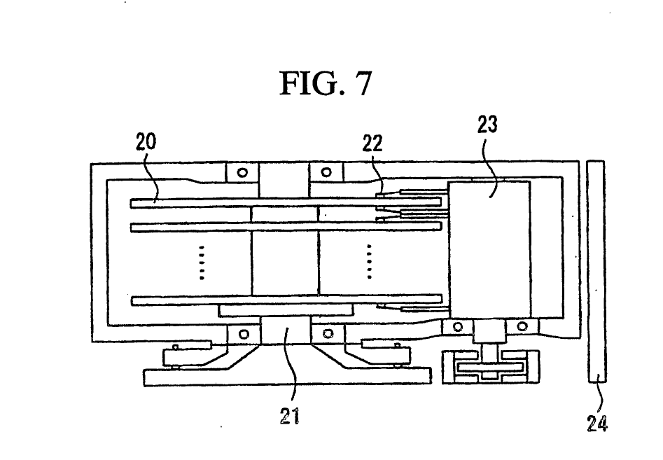

FIG. 7 shows an exemplary magnetic recording and reproducing apparatus according to the present invention.

The magnetic recording and reproducing apparatus as shown in FIG. 7 comprises the magnetic recording medium 20, a medium-driving member 21 for rotating the magnetic recording medium 20, a magnetic head 22 for recording information in and reproducing information from the magnetic recording medium 20, a head-driving member 23 for moving the magnetic head 22 relative to the magnetic recording medium 20, and a record reproduction signal processing system 24.

The record reproduction signal processing system 24 is provided such that data input from the outside is processed to transmit a record signal to the magnetic head 22 and that a reproduction signal obtained from the magnetic head 22 is processed to transmit data to the outside.

As the magnetic head 22, a head suitably used for high recording density, such as a head comprising, as a reproduction element, not only a magnetororesistance (MR) element based on anisotropic magnetroresistance (AMR) but also a giant magnetoresistance (GMR) element based on giant magnetoresistance (GMR), can be used. Recording density can be increased by employing a GMR element.

Since the magnetic recording and reproducing apparatus employs the magnetic recording medium comprising the first magnetic layer made of a CoCrZr-based alloy, media noise can be reduced.

### EXAMPLES

Below, the effects of the present invention will be explained with reference to embodiments.

### Example 1

On the surface of a substrate (outer diameter: 95 mm, inner diameter: 25 mm, and thickness: 1.270 mm) made of Al, an NiP film (thickness: 12 μM) was made by electroless plating. Then, the surface of the NiP film was subjected to a texturing process, and a non-magnetic substrate having a surface average roughness (Ra) of 0.5 nm was prepared.

The prepared non-magnetic substrate was placed in a DC magnetron sputtering apparatus (C3010, product of ANELVA (Japan)), and the chamber was evacuated to 2×10⁻⁷ Torr (2.7×10⁻⁵ Pa), after that, the non-magnetic substrate was heated to 250° C.

On the non-magnetic substrate, a non-magnetic undercoat layer was formed. The non-magnetic undercoat layer had a multi-layer structure comprising a first layer (thickness: 5 nm) made of Cr and a second layer (thickness: 3 nm) made of a CrMo alloy (Cr:80 at. % and Mo: 20 at. %), which was formed on the first layer.

A first magnetic layer (thickness: 2 nm) made of a CoCrZr alloy (Co: 75 at. %, Cr: 20 at. %, and Zr: 5 at. %) was formed on the second layer of the non-magnetic undercoat layer.

A non-magnetic coupling layer (thickness: 0.8 nm) made of Ru was formed on the first magnetic layer.

A second magnetic layer (thickness: 20 nm) made of a CoCrPtB alloy (Co: 60 at. %, Cr: 22 at. %, Pt: 12 at. %, and B: 6 at. %) was formed on the non-magnetic coupling layer.

After that, a protective layer (thickness: 5 nm) made of carbon was formed on the second magnetic layer.

During formation of each layer, Ar was used as a sputtering gas, and the pressure thereof was adjusted to 3 mTorr.

Subsequently, a lubricant containing perfluoropolyether was applied to the surface of the protective layer so as to form a lubrication layer (thickness: 2 nm), to thereby prepare a magnetic recording medium.

### Example 2

A magnetic recording medium was prepared in a manner identical to that of Example 1, except that the first magnetic layer was made of a CoCrZr alloy (Co: 81 at. %, Cr: 14 at. %, and Zr: 5 at. %).

### Example 3

A magnetic recording medium was prepared in a manner identical to that of Example 1, except that the first magnetic layer was made of a CoCrZr alloy (Co: 79 at. %, Cr: 16 at. %, and Zr: 5 at. %).

### Example 4

A magnetic recording medium was prepared in a manner identical to that of Example 1, except that the first magnetic layer was made of a CoCrZr alloy (Co: 77 at. %, Cr: 18 at. %, and Zr: 5 at. %).

### Example 5

A magnetic recording medium was prepared in a manner identical to that of Example 1, except that the first magnetic layer was made of a CoCrZr alloy (Co: 73 at. %, Cr: 22 at. %, and Zr: 5 at. %).

### Example 6

A magnetic recording medium was prepared in a manner identical to that of Example 1, except that the first magnetic layer was made of a CoCrZr alloy (Co: 71 at. %, Cr: 24 at. %, and Zr: 5 at. %).

### Example 7

A magnetic recording medium was prepared in a manner identical to that of Example 1, except that the first magnetic layer was made of a CoCrZr alloy (Co: 79 at. %, Cr: 20 at. %, and Zr: 1 at. %).

### Example 8

A magnetic recording medium was prepared in a manner identical to that of Example 1, except that the first magnetic layer was made of a CoCrZr alloy (Co: 77 at. %, Cr: 20 at. %, and Zr: 3 at. %).

### Example 9

A magnetic recording medium was prepared in a manner identical to that of Example 1, except that the first magnetic layer was made of a CoCrZr alloy (Co: 73 at. %, Cr: 20 at. %, and Zr: 7 at. %).

### Example 10

A magnetic recording medium was prepared in a manner identical to that of Example 1, except that the first magnetic layer was made of a CoCrZr alloy (Co: 71 at. %, Cr: 20 at. %, and Zr: 9 at. %).

### Example 11

A magnetic recording medium was prepared in a manner identical to that of Example 1, except that the first magnetic layer was made of a CoCrZr alloy (Co: 69 at. %, Cr: 20 at. %, and Zr: 11 at. %).

### Example 12

A magnetic recording medium was prepared in a manner identical to that of Example 1, except that the first magnetic layer was made of a CoCrZrB alloy (Co: 73 at. %, Cr: 20 at. %, Zr: 5 at. %, and B: 2 at. %).

### Comparative Example 1

A comparative magnetic recording medium was prepared in a manner identical to that of Example 1, except that the first magnetic layer was made of a CoCr alloy (Co: 80 at. % and Cr: 20 at. %).

### Comparative Example 2

A comparative magnetic recording medium was prepared in a manner identical to that of Example 1, except that the first magnetic layer was made of a CoCrTa alloy (Co: 75 at. %, Cr: 20 at. %, and Ta: 5 at. %).

### Comparative Example 3

A comparative magnetic recording medium was prepared in a manner identical to that of Example 1, except that the second magnetic layer was made of a CoCrZr alloy (Co: 75 at. %, Cr: 20 at. %, and Zr: 5 at. %).

### Example 13

A non-magnetic substrate having a surface average roughness (Ra) of 0.3 nm was prepared by subjecting a glass substrate (outer diameter: 65 mm, inner diameter: 20 mm, and thickness: 0.635 mm) in a texturing process.

The prepared non-magnetic substrate was placed in a DC magnetron sputtering apparatus (C3010, product of ANELVA (Japan)), and the chamber was evacuated to 2×10⁻⁷ Torr (2.7×10⁻⁵ Pa).

On the non-magnetic substrate, an orientation adjustment layer (thickness: 5 nm) made of a CoW alloy (Co: 50 at. % and W: 50 at. %) was formed, and then this was heated to 250° C.

After that, the surface of the orientation adjustment layer was exposed to oxygen gas. The oxygen pressure and the exposure time were controlled to 0.05 Pa and 5 seconds, respectively.

A non-magnetic undercoat layer made of a CrTiB alloy (Cr: 82 at. %, Ti: 16 at. %, and B: 2 at. %), was formed on the orientation adjustment layer.

A first magnetic layer (thickness: 2 nm) made of a CoCrZr alloy (Co: 81 at. %; Cr: 14 at. %; and Zr: 5 at. %) was formed on the non-magnetic undercoat layer.

A non-magnetic coupling layer (thickness: 0.8 mm) made of Ru was formed on the first magnetic layer.

A second magnetic layer (thickness: 20 nm) made of a CoCrPtB alloy (Co: 60 at. %, Cr: 22 at. %, Pt: 12 at. %, and B: 6 at. %) was formed on the non-magnetic coupling layer.

After that, a protective layer (thickness: 5 nm) made of carbon was formed.

During formation of each layer, Ar was used as a sputtering gas, and the pressure thereof was adjusted to 3 mTorr.

Subsequently, a lubricant containing perfluoropolyether was applied to the surface of the protective layer so as to form a lubrication layer (thickness: 2 nm), to thereby prepare a magnetic recording medium.

### Example 14

A magnetic recording medium was prepared in a manner identical to that of Example 13, except that the first magnetic layer was made of a CoCrZr alloy (Co: 87 at. %, Cr: 8 at. %, and Zr: 5 at. %).

### Example 15

A magnetic recording medium was prepared in a manner identical to that of Example 13, except that the first magnetic layer was made of a CoCrZr alloy (Co: 85 at. %, Cr: 10 at. %, and Zr: 5 at. %).

### Example 16

A magnetic recording medium was prepared in a manner identical to that of Example 13, except that the first magnetic layer was made of a CoCrZr alloy (Co: 83 at. %, Cr: 12 at. %, and Zr: 5 at. %).

### Example 17

A magnetic recording medium was prepared in a manner identical to that of Example 13, except that the first magnetic layer was made of a CoCrZr alloy (Co: 79 at. %, Cr: 16 at. %, and Zr: 5 at. %).

### Example 18

A magnetic recording medium was prepared in a manner identical to that of Example 13, except that the first magnetic layer was made of a CoCrZr alloy (Co: 77 at. %, Cr: 18 at. %, and Zr: 1 at. %).

### Example 19

A magnetic recording medium was prepared in a manner identical to that of Example 13, except that the first magnetic layer was made of a CoCrZr alloy (Co: 85 at. %, Cr: 14 at. %, and Zr: 1 at. %).

### Example 20

A magnetic recording medium was prepared in a manner identical to that of Example 13, except that the first magnetic layer was made of a CoCrZr alloy (Co: 83 at. %, Cr: 14 at. %, and Zr: 3 at. %).

### Example 21

A magnetic recording medium was prepared in a manner identical to that of Example 13, except that the first magnetic layer was made of a CoCrZr alloy (Co: 79 at. %, Cr: 14 at. %, and Zr: 7 at. %).

### Example 22

A magnetic recording medium was prepared in a manner identical to that of Example 13, except that the first magnetic layer was made of a CoCrZr alloy (Co: 77 at. %, Cr: 14 at. %, and Zr: 9 at. %).

### Example 23

A magnetic recording medium was prepared in a manner identical to that of Example 13, except that the first magnetic layer was made of a CoCrZr alloy (Co: 75 at. %, Cr: 14 at. %, and Zr: 11 at. %).

### Comparative Example 4

A comparative magnetic recording medium was prepared in a manner identical to that of Example 13, except that the first magnetic layer was made of a CoCr alloy (Co: 86 at. % and Cr: 14 at. %).

### Comparative Example 5

A comparative magnetic recording medium was prepared in a manner identical to that of Example 13, except that the first magnetic layer was made of a CoCrTa alloy (Co: 81 at. %, Cr: 14 at. %, and Ta: 5 at. %).

### Example 24

On the surface of a substrate (outer diameter: 95 mm, inner diameter: 25 mm, and thickness: 1.270 mm) made of Al, an NiP film (thickness: 12 μm) was made by electroless plating. Then, the surface of the NiP-based alloy film was subjected to a texturing process, and a non-magnetic substrate having a surface average roughness (Ra) of 0.5 nm was prepared.

The prepared non-magnetic substrate was placed in a DC magnetron sputtering apparatus (C3010, product of ANELVA (Japan)), and the chamber was evacuated to 2×10⁻⁷ Torr (2.7×10⁻⁵ Pa), after that, the non-magnetic substrate was heated to 250° C.

On the non-magnetic substrate, a non-magnetic undercoat layer was formed. The non-magnetic undercoat layer had a multi-layer structure comprising a first layer (thickness: 5 nm) made of Cr and a second layer (thickness: 3 nm) made of a CrMo alloy (Cr: 80 at. % and Mo: 20 at. %), which was formed on the first layer.

A first magnetic layer (thickness: 2 nm) made of a CoCrZr alloy (Co: 75 at. %, Cr: 20 at. %, and Zr: 5 at. %) was formed on the second layer of the non-magnetic undercoat layer.

A first non-magnetic coupling layer (thickness: 0.8 nm) made of Ru was formed on the first magnetic layer.

A second magnetic layer (thickness: 4 nm) made of a CoCrPtB alloy (Co: 69 at. %, Cr: 22 at. %, Pt: 5 at. %, and B: 4 at. %) was formed on the first non-magnetic coupling layer.

A second non-magnetic coupling layer (thickness: 0.8 nm) made of Ru was formed on the second magnetic layer.

A third magnetic layer (thickness: 15 nm) made of a CoCrPtB alloy (Co: 60 at. %, Cr: 22 at. %, Pt: 12 at. %, and B: 6 at. %) was formed on the second non-magnetic coupling layer.

After that, a protective layer (thickness: 5 nm) made of carbon was formed.

During formation of each layer, Ar was used as a sputtering gas, and the pressure thereof was adjusted to 3 mTorr.

Subsequently, a lubricant containing perfluoropolyether was applied to the surface of the protective layer so as to form a lubrication layer (thickness: 2 μm), to thereby prepare a magnetic recording medium.

### Comparative Example 6

A comparative magnetic recording medium was prepared in a manner identical to that of Example 24, except that the first magnetic layer was made of a CoCr alloy (Co: 80 at. % and Cr: 20 at. %).

### Comparative Example 7

A comparative magnetic recording medium was prepared in a manner identical to that of Example 24, except that the first magnetic layer was made of a CoCrTa alloy (Co: 75 at. %, Cr: 20 at. %, and Ta: 5 at. %).

Each of magnetic recording media produced in the above Examples and Comparative Examples was subjected to a glide test by use of a glide tester, with the glide height being adjusted to 0.3 μinch (1 inch≈25.4 mm). The recording media which had passed the test were further investigated in terms of record reproduction characteristics by use of a read-write analyzer RWA 1632 (product of GUZIK (USA)).

The record reproduction characteristics were investigated in terms of electromagnetic transducing characteristics (track average amplitude total (TAA), 50% pulse width (PW50), an SNR, and an overwrite (OW)).

The record reproduction characteristics were evaluated using a complex thin-film magnetic recording head comprising a giant magnetoresistance (GMR) element as a readout portion.

Noise evaluation was performed by measuring the integral noise from 1 MHz to a frequency corresponding to 500 kFCI generated when a pattern signal of 500 kFCI had been written. Read output was adjusted to 250 kFCI and an SNR is calculated by formula: SNR=20×log(read output/integral noise from 1 MHz to a frequency corresponding to 500 kFCI).

Coercive force (Hc) and squareness ratio (S*) were determined using a Kerr effect magnetic characteristics analyzer (RO1900, product of Hitachi Electronics Engineering (Japan)).

The results are shown in Tables 1-1 and 1-2.

TABLE 1-1

| | First magnetic | Second magnetic | Third magnetic | Coercive | Squareness | | | | |
|---|---|---|---|---|---|---|---|---|---|
| | layer | layer | layer | force | ratio | TAA | OW | PW50 | SNR |
| | Composition | composition | composition | (Oe) | (—) | (μV) | (dB) | (ns) | (dB) |
| Ex. 1 | 75Co20Cr5Zr | 60Co22Cr12Pt6B | — | 4,351 | 0.81 | 1,354 | 37.5 | 9.42 | 18.5 |
| Ex. 2 | 81Co14Cr5Zr | 60Co22Cr12Pt6B | — | 4,325 | 0.83 | 1,225 | 39.2 | 9.21 | 18.7 |
| Ex. 3 | 79Co16Cr5Zr | 60Co22Cr12Pt6B | — | 4,295 | 0.84 | 1,249 | 39.0 | 9.26 | 18.7 |
| Ex. 4 | 77Co18Cr5Zr | 60Co22Cr12Pt6B | — | 4,335 | 0.81 | 1,329 | 38.1 | 9.37 | 18.4 |
| Ex. 5 | 73Co22Cr5Zr | 60Co22Cr12Pt6B | — | 4,367 | 0.80 | 1,385 | 37.1 | 9.52 | 18.4 |
| Ex. 6 | 71Co24Cr5Zr | 60Co22Cr12Pt6B | — | 4,271 | 0.75 | 1,396 | 37.5 | 9.74 | 17.5 |
| Ex. 7 | 79Co20Cr1Zr | 60Co22Cr12Pt6B | — | 4,251 | 0.78 | 1,302 | 38.4 | 9.58 | 18.1 |
| Ex. 8 | 77Co20Cr3Zr | 60Co22Cr12Pt6B | — | 4,325 | 0.80 | 1,317 | 37.9 | 9.49 | 18.7 |
| Ex. 9 | 73Co20Cr7Zr | 60Co22Cr12Pt6B | — | 4,396 | 0.82 | 1,368 | 36.6 | 9.49 | 18.6 |
| Ex. 10 | 71Co20Cr9Zr | 60Co22Cr12Pt6B | — | 4,357 | 0.81 | 1,396 | 36.2 | 9.55 | 18.2 |
| Ex. 11 | 69Co20Cr11Zr | 60Co22Cr12Pt6B | — | 4,311 | 0.74 | 1,392 | 37.5 | 9.76 | 17.6 |
| Ex. 12 | 73Co20Cr5Zr2B | 60Co22Cr12Pt6B | — | 4,352 | 0.80 | 1,365 | 37.6 | 9.45 | 18.7 |
| Ex. 13 | 81Co14Cr5Zr | 60Co22Cr12Pt6B | — | 4,392 | 0.81 | 1,196 | 39.6 | 9.30 | 18.4 |
| Ex. 14 | 87Co8Cr5Zr | 60Co22Cr12Pt6B | — | 4,311 | 0.83 | 986 | 41.0 | 9.12 | 18.3 |
| Ex. 15 | 85Co10Cr5Zr | 60Co22Cr12Pt6B | — | 4,355 | 0.82 | 1,036 | 40.5 | 9.18 | 18.4 |
| Ex. 16 | 83Co12Cr5Zr | 60Co22Cr12Pt6B | — | 4,295 | 0.81 | 1,125 | 39.9 | 9.25 | 18.4 |
| Ex. 17 | 79Co16Cr5Zr | 60Co22Cr12Pt6B | — | 4,371 | 0.80 | 1,256 | 38.6 | 9.37 | 18.4 |
| Ex. 18 | 77Co18Cr5Zr | 60Co22Cr12Pt6B | — | 4,381 | 0.79 | 1,291 | 37.5 | 9.45 | 18.2 |
| Ex. 19 | 85Co14Cr1Zr | 60Co22Cr12Pt6B | — | 4,291 | 0.78 | 1,112 | 39.8 | 9.34 | 17.9 |
| Ex. 20 | 83Co14Cr3Zr | 60Co22Cr12Pt6B | — | 4,288 | 0.79 | 1,137 | 38.9 | 9.37 | 18.5 |
| Ex. 21 | 79Co14Cr7Zr | 60Co22Cr12Pt6B | — | 4,312 | 0.81 | 1,219 | 37.8 | 9.40 | 18.4 |
| Ex. 22 | 77Co14Cr9Zr | 60Co22Cr12Pt6B | — | 4,362 | 0.82 | 1,265 | 37.4 | 9.51 | 18.2 |
| Ex. 23 | 75Co14Cr11Zr | 60Co22Cr12Pt6B | — | 4,278 | 0.77 | 1,291 | 37.2 | 9.63 | 17.6 |
| Ex. 24 | 75Co20Cr5Zr | 69Co22Cr5Pt4B | 60Co22Cr12Pt6B | 4,356 | 0.80 | 1,351 | 35.8 | 9.41 | 18.1 |

TABLE 1-2

| | First magnetic | Second magnetic | Third magnetic | Coercive | Squareness | | | | |
|---|---|---|---|---|---|---|---|---|---|
| | layer | layer | layer | force | ratio | TAA | OW | PW50 | SNR |
| | Composition | composition | composition | (Oe) | (—) | (μV) | (dB) | (ns) | (dB) |
| Comp. Ex. 1 | 80Co20Cr | 60Co22Cr12Pt6B | — | 4,216 | 0.76 | 1,265 | 37.2 | 9.62 | 17.4 |
| Comp. Ex. 2 | 75Co20Cr5Ta | 60Co22Cr12Pt6B | — | 4,319 | 0.79 | 1,341 | 37.9 | 9.64 | 17.6 |
| Comp. Ex. 3 | 75Co20Cr5Zr | 75Co20Cr5Zr | — | 1,126 | 0.81 | 1,349 | 42.5 | 10.93 | 11.6 |
| Comp. Ex. 4 | 86Co14Cr | 60Co22Cr12Pt6B | — | 4,196 | 0.74 | 1,185 | 38.9 | 9.52 | 17.3 |
| Comp. Ex. 5 | 81Co14Cr5Ta | 60Co22Cr12Pt6B | — | 4,215 | 0.77 | 1,218 | 39.6 | 9.69 | 17.5 |
| Comp. Ex. 6 | 80Co20Cr | 69Co22Cr5Pt4B | 60Co22Cr12Pt6B | 4,311 | 0.75 | 1,301 | 38.2 | 9.53 | 17.2 |
| Comp. Ex. 7 | 75Co20Cr5Ta | 69Co22Cr5Pt4B | 60Co22Cr12Pt6B | 4,322 | 0.74 | 1,321 | 38.4 | 9.56 | 17.1 |

In tables 1-1 and 1-2, for example, 75Co20Cr5Zr denotes Co: 75 at. %, Cr: 20 at. %, and Zr: 5 at. %.

In Examples 1 to 12, and 24, and Comparative Examples 1 to 3 and 6, an Al substrate was used for the non-magnetic substrate. In Examples 13 to 23 and Comparative Examples 4 and 5, a glass substrate was used for the non-magnetic substrate.

It is clear from Examples 1 to 6 that when the Cr content in a CoCrZr-based alloy making the first magnetic layer is in a range of 14 to 22 at. %, the magnetic recording medium has an improved SNR. In contrast, when the Cr content is 24 at. %, magnetization is insufficient and an SNR decreases.

It is clear from Examples 1 and 7 to 11 that when the Zr content in a CoCrZr-based alloy making the first magnetic layer is in a range of 1 to 9 at. %, the magnetic recording medium has an improved SNR. In particular, when the Zr content is in a range of 3 to 7 at. %, an SNR is a maximum. When the Zr content is 11 at. %, magnetization is insufficient and an SNR decreases.

It is clear from Example 12 that an SNR is improved by adding B as an additive element to a CoCrZr-based alloy making the first magnetic layer.

It is clear from Comparative Examples 1 and 2 that when a CoCr-based alloy or a CoCrTa-based alloy is used for the first magnetic layer, the magnetic recording layer has an inferior SNR to that of the magnetic recording layer comprising the first magnetic layer made of a CoCrZr-based alloy.

It is clear from Comparative Example 3 that when a CoCrZr-based alloy is used for the second magnetic layer, coercive force remarkably decreases and an SNR also remarkably decreases.

It is clear from Examples 13 to 18 that when the Cr content in a CoCrZr-based alloy making the first magnetic layer is in a range of 8 to 18 at. %, the magnetic recording medium has an improved SNR.

It is clear from Examples 19 to 23 that when the Zr content in a CoCrZr-based alloy making the first magnetic layer is in a range of 1 to 9 at. %, the magnetic recording medium has an improved SNR. In particular, when the Zr content is in a range of 3 to 7 at. %, an SNR is a maximum. When the Zr content is 11 at. %, problems are not caused in magnetization but a squareness ratio and an SNR decrease.

It is clear from Comparative Examples 3 and 4 that when a CoCr-based alloy or a CoCrTa-based alloy is used for the first magnetic layer, the magnetic recording layer has an inferior SNR to that of the magnetic recording layer comprising the first magnetic layer made of a CoCrZr-based alloy.

The magnetic recording medium of Example 24 comprises the first magnetic layer, the first non-magnetic coupling layer, the second magnetic layer, the second non-magnetic coupling layer, and the third magnetic layer (that is, the magnetic recording medium comprises three magnetic layers and two non-magnetic coupling layers). In the magnetic recording medium having a such structure, when the first magnetic layer is made of a CoCrZr-based alloy, the magnetic recording medium has a superior SNR to that of the magnetic recording media of Comparative Examples 6 and 7.

### INDUSTRIAL APPLICABILITY

Since the magnetic recording medium of the present invention comprises the first magnetic layer made of a CoCrZr-based alloy, media noise is reduced.

1. A magnetic recording medium comprising at least a non-magnetic undercoat layer, a first magnetic layer, a non-magnetic coupling layer, a second magnetic layer, and a protective layer, in this order, on a non-magnetic substrate,
wherein the second magnetic layer is anti-ferromagnetically coupled with the first magnetic layer; and
the first magnetic layer is made of a CoCrZr alloy.

2. A magnetic recording medium comprising at least a non-magnetic undercoat layer, a first magnetic layer, a non-magnetic coupling layer, a second magnetic layer, a non-magnetic coupling layer, a third magnetic layer, and a protective layer, in this order, on a non-magnetic substrate,
wherein the third magnetic layer is antiferromagnetically coupled with the second magnetic layer;
the second magnetic layer is antiferromagnetically coupled with the first magnetic layer; and
the first magnetic layer is made of a CoCrZr alloy.

3. A magnetic recording medium according to claim 1, wherein the first magnetic layer contains 5 to 22 at. % of Cr and 1 to 10 at. % of Zr.

4. A magnetic recording medium according to claim 1, wherein the thickness of the first magnetic layer is in a range of 0.5 to 10 nm.

5. A magnetic recording medium according to claim 1, wherein the non-magnetic coupling layer is made of at least one of Ru, Rh, Ir, Cr, Re, an Ru-based alloy, an Rh-based alloy, an Ir-based alloy, a Cr-based alloy, and an Re-based alloy; and the thickness of the non-magnetic coupling layer is in a range of 0.5 to 1.5 nm.

6. A magnetic recording medium according to claim 1, wherein the non-magnetic undercoat layer has a multi-layer structure comprising a layer made of Cr or a layer made of a Cr-based alloy containing Cr and at least one of Ti, Mo, Al, Ta, W, Ni, B, Si, and V.

7. A magnetic recording medium according to claim 1, wherein the non-magnetic undercoat layer has a multi-layer structure comprising a layer containing one of NiAl-based alloy, RuAl-based alloy, and Cr-based alloy; and the Cr-based alloy contains Cr and at least one of Ti, Mo, Al, Ta, W, Ni, B, Si, and V.

8. A magnetic recording medium according to claim 1, wherein the non-magnetic substrate is one of a glass substrate and a silicon substrate.

9. A magnetic recording medium according to claim 1, wherein the non-magnetic substrate comprises a substrate made of one of Al, an Al-based alloy, glass, and silicon; on which a film containing one of NiP and an NiP alloy is formed.

10. A magnetic recording medium according to claim 1, wherein the second magnetic layer is made of at least one of a CoCrTa-based alloy, a CoCrPtTa-based alloy, a CoCrPtB-based alloy, and a CoCrPtBM-based alloy (wherein M denotes at least one of Ta and Cu).

11. A magnetic recording medium according to claim 2, wherein the second magnetic layer and the third magnetic layer are made of at least one of a CoCrTa-based alloy, a CoCrPtTa-based alloy, a CoCrPtB-based alloy, and a CoCrPtBM-based alloy (wherein M denotes at least one of Ta and Cu).

12. A method for producing a magnetic recording medium comprising at least a non-magnetic undercoat layer, a first magnetic layer, a non-magnetic coupling layer, a second magnetic layer, and a protective layer, in this order, on a non-magnetic substrate, and the second magnetic layer being antiferromagnetically coupled with the first magnetic layer,
wherein the method comprises the step in which the first magnetic layer is made of a CoCrZr alloy.

13. A method for producing a magnetic recording medium comprising at least a non-magnetic undercoat layer, a first magnetic layer, a non-magnetic coupling layer, a second magnetic layer, a non-magnetic coupling layer, a third magnetic layer, and a protective layer, in this order, on a non-magnetic substrate, the third magnetic layer being antiferromagnetically coupled with the second magnetic layer, and the second magnetic layer being antiferromagnetically coupled with the first magnetic layer,
wherein the method comprises the step in which the first magnetic layer is made of a CoCrZr alloy.

14. A magnetic recording and reproducing apparatus comprising a magnetic recording medium according to claim 1 and a magnetic head for recording information in the magnetic recording medium and reproducing information from the magnetic recording medium.
